(19) United States
(12) Patent Application Publication
(10) Pub. No.: US 2008/0074800 A1
(43) Pub. Date: Mar. 27, 2008

(54) MANUFACTURING METHOD OF THIN-FILM MAGNETIC HEAD AND THIN-FILM MAGNETIC HEAD

(75) Inventors: Takeo KAGAMI, Tokyo (JP); Naoki OHTA, Tokyo (JP); Kosuke TANAKA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 11/855,190

(22) Filed: Sep. 14, 2007

(30) Foreign Application Priority Data
Sep. 26, 2006 (JP) 2006-260124

(51) Int. Cl. G11B 5/33

(52) U.S. Cl. 360/314

(57) ABSTRACT

A manufacturing method of a thin-film magnetic head with an MR read head element, includes an MR film deposition step of depositing on a lower magnetic shield layer an MR multi-layered film, a first patterning step of patterning the deposited MR multi-layered film for defining a track width using a first mask, a first lift-off step of depositing at least an insulation film and a magnetic domain control film under a state where the first mask used the first patterning step is remained and removing the first mask to form a magnetic domain control layer, a second patterning step of patterning the MR multi-layered films for defining a width in a height direction that is perpendicular to a track-width direction to form a MR multi-layered structure, and a upper shield layer deposition step of depositing an upper magnetic shield layer. A length in the height direction that is perpendicular to the track-width direction, of the magnetic domain control layer near the MR multi-layered structure is longer than a length in the height direction of the MR multi-layered structure. The method further includes a planarization step of planarizing an upper surface. This planarization step is performed after the second patterning step but before the upper shield layer deposition step.

### PRIORITY CLAIM

This application claims priority from Japanese patent application No. 2006-260124, filed on Sep. 26, 2006, which is incorporated herein by reference.

### BACKGROUND OF THE INVENTION

1. Field of the Invention

The present invention relates to a manufacturing method of a thin-film magnetic head with a magnetoresistive effect (MR) read head element for detecting magnetic intensity in a magnetic recording medium and for outputting a read signal, and to a thin-film magnetic head.

2. Description of the Related Art

As hard disk drive apparatuses (HDD) increase in capacity and reduce in size, highly sensitive and high-output thin-film magnetic heads are being demanded. In order to satisfy the demand, performance of giant magnetoresistive effect (GMR) thin-film magnetic heads with GMR read head elements are being improved. On the other hand, tunnel magnetoresistive effect (TMR) thin-film magnetic heads with TMR read head elements having a magnetoresistivity ratio more than twice as high as that of the GMR thin-film magnetic heads are being developed.

TMR thin-film heads differ from conventional GMR thin-film magnetic head in head structure because of the difference in the flowing direction of sense current. The head structure in which sense current flows in a direction parallel to the lamination planes or film planes as in typical GMR thin-film heads is called as CIP (Current-In-Plane) structure, whereas the structure in which sense current flows in a direction perpendicular to the film planes as in TMR thin-film magnetic heads is called as CPP (Current-Perpendicular-to-Plane) structure, respectively. Recently, CPP-GMR thin-film heads are also being developed.

Because the CPP-GMR heads and the TMR heads utilize magnetic shield layers themselves as electrodes, short-circuit or insufficient insulation between magnetic shield layers and element layer, which had been serious problem for narrowing the read gap in the CIP-GMR heads never inherently occurs. Therefore, the CPP-GMR heads and the TMR heads lend themselves to high recording density heads.

In general, on both side ends in a track-width direction of a TMR multi-layered structure of such TMR head or of a GMR multi-layered structure of such CPP-GMR head, provided is a magnetic domain control bias layer for controlling magnetic domain in its magnetization-free layer. However, if a read gap is narrowed with keeping flatness of lower and upper magnetic shield layers near the TMR multi-layered structure or the GMR multi-layered structure, it is impossible to make thick the magnetic domain control bias layer and therefore it is difficult to provide sufficient bias magnetic field to the TMR multi-layered structure or the GMR multi-layered structure.

Japanese patent publication No. 2005-011449A, and US patent publications Nos. 2006/067010 and 2005/270703 disclose a biasing method for securing enough bias magnetic field to apply strong magnetic bias to the TMR multi-layered structure or the GMR multi-layered structure without increasing the thickness of the magnetic domain control bias layer, in which it is configured that a length in a height direction (a direction perpendicular to a track-width direction in a lamination plane) of the magnetic domain control bias layer is longer than a length in the height direction of the TMR multi-layered structure or the GMR multi-layered structure.

FIGS. 1a and 1b illustrate a lamination plane of an MR read head element having a structure where a length in the height direction of a magnetic domain control bias layer 11 near an MR multi-layered structure 10 (bias height, Bias-H) is longer than a length in the height direction of the MR multi-layered structure 10 (MR height, MR-H) as disclosed in these patent publications. It should be noted that FIG. 1a indicates the structure before an MR-height adjustment process, and FIG. 1b indicates that after the MR-height adjustment process. The magnetic domain control bias layer 11 is remained as it is even after a milling process for defining a width along the height direction of the MR multi-layered structure 10 is performed if the magnetic domain control bias layer 11 itself or a bias protection layer laminated thereon is sufficiently thick or is made of a material with a low milling rate, and thus the bias height becomes greater than the MR height, namely Bias-H>MR-H.

FIGS. 2a and 2b illustrate a lamination plane of an MR read head element having a structure where a bias height Bias-H′ of a magnetic domain control bias layer 11′ near an MR multi-layered structure 10′ is substantially equal to an MR height MR-H′ of the MR multi-layered structure 10′. It should be noted that FIG. 2a indicates the structure before an MR-height adjustment process, and FIG. 2b indicates that after the MR-height adjustment process. An unmasked portion of the magnetic domain control bias layer 11′ is completely removed after a milling process for defining a width along the height direction of the MR multi-layered structure 10′ is performed if the magnetic domain control bias layer 11′ itself or a bias protection layer laminated thereon is thin or is made of a material with a high milling rate, and thus the bias height becomes substantially equal to the MR height, namely Bias-H MR-H.

Hereinafter, for the sake of convenience, the structure of Bias-H>MR-H as shown in FIGS. 1a and 1b will be called as a wide-type magnetic domain control bias layer, and the structure of Bias-H MR-H as shown in FIGS. 2a and 2b will be called as a narrow-type magnetic domain control bias layer.

In general, in thin-film magnetic heads with the wide-type magnetic domain control bias layers, the magnetic domain control bias layer itself or the bias protection layer laminated thereon rises with respect to the upper surface of the MR multi-layered structure and thus a step may be formed between the magnetic domain control bias layer and the MR multilayered structure causing a flatness of an upper magnetic shield layer laminated thereon to extremely deteriorate. If deterioration in the flatness of the upper magnetic shield layer will make coupling between the upper magnetic shield layer and the free layer to worse causing the MR output to make unstable and the stabilization of the MR read head element to lower.

### SUMMARY OF THE INVENTION

It is therefore an object of the present invention to provide a manufacturing method of a thin-film magnetic head whereby an upper magnetic shield layer with good flatness can be fabricated even if a wide-type magnetic domain control bias layer is provided, and to provide a thin-film magnetic head having a wide-type magnetic domain control bias layer and an upper magnetic shield layer with good flatness.

According to the present invention, a manufacturing method of a thin-film magnetic head with an MR read head element, includes an MR film deposition step of depositing on a lower magnetic shield layer an MR multi-layered film, a first patterning step of patterning the deposited MR multi-layered film for defining a track width using a first mask, a first lift-off step of depositing at least an insulation film and a magnetic domain control film under a state where the first mask used the first patterning step is remained and removing the first mask to form a magnetic domain control layer, a second patterning step of patterning the MR multi-layered films for defining a width in a height direction that is perpendicular to a track-width direction to form a MR multi-layered structure, and a upper shield layer deposition step of depositing an upper magnetic shield layer. A length in the height direction that is perpendicular to the track-width direction, of the magnetic domain control layer near the MR multi-layered structure is longer than a length in the height direction of the MR multi-layered structure. The method further includes a planarization step of planarizing an upper surface. This planarization step is performed after the second patterning step but before the upper shield layer deposition step.

A length in the height direction that is perpendicular to the track-width direction, of the magnetic domain control layer near the MR multi-layered structure is longer than a length in the height direction of the MR multi-layered structure. In other words, the magnetic domain control layer is wide type. The planarization step of surfaces is performed after the second patterning step for defining the width in the height direction but before the upper shield layer deposition step. Thus, even if the wide-type magnetic domain control layer is provided, the upper magnetic shield layer can be formed with good flatness. As a result, it is possible to provide a thin-film magnetic head with an MR read head element having a good stabilization in MR output even when the read gap is narrowed to satisfy higher recording density demands.

In this specification, “lift-off process” includes any process for removing a mask and films deposited thereon by mechanical and/or chemical method.

It is preferred that the first lift-off step includes a step of sequentially depositing an insulation film, a magnetic domain control film and a magnetic domain control protection film under a state where the first mask used in the first patterning step is remained and a step of removing the first mask.

It is also preferred that the first lift-off step includes a step of sequentially depositing only an insulation film and a magnetic domain control film under a state where the first mask used in the first patterning step is remained and a step of removing the first mask.

It is further preferred that the method further includes a second lift-off step of depositing at least an insulation film under a state where a second mask used in the second patterning step is remained and removing the second mask, and that the second lift-off step is performed after the second patterning step but before the planarization step. In this case, preferably, the second lift-off step includes a step of sequentially depositing an insulation film and a planarization stop film under a state where the second mask used in the second patterning step is remained and a step of removing the second mask.

It is still further preferred that the method further includes a planarization stop film deposition step of depositing an insulation film and a planarization stop film under a state where a second mask used in the second patterning step is remained, that the planarization stop film deposition step is performed after the second patterning step but before the planarization step, and wherein the planarization step is performed without executing lift-off.

It is further preferred that the planarization step includes a step of executing chemical mechanical polishing (CMP) or executing wet etching. In the latter case, the magnetic domain control protection film is formed by alumina (Al₂O₃) and etching using such as alkaline liquid solution is performed for planarization.

It is still further preferred that the MR film deposition step includes a step of depositing a TMR multi-layered film or a CPP-GMR multi-layered film.

It is further preferred that the method further includes a step of forming an inductive write head element on the upper magnetic shield layer of the MR read head element.

It is still further preferred that the method further includes a step of forming many thin-film magnetic heads on a wafer, a step of cutting the wafer into a plurality of bars so that each bar has a plurality of thin-film magnetic heads aligned with each other, a step of lapping each bar, and a step of separating the lapped bar into a plurality of individual thin-film magnetic heads.

According to the present invention, also, a thin-film magnetic head with a MR read head element, includes a lower magnetic shield layer, a MR multi-layered structure formed on the lower magnetic shield layer, in which current flows in a direction perpendicular to a layer lamination plane, a magnetic domain control layer formed on both side surfaces in a track-width direction of the MR multi-layered structure, and an upper magnetic shield layer formed on the MR multi-layered structure and the magnetic domain control layer. A length in a height direction that is perpendicular to the track-width direction, of the magnetic domain control layer near the MR multi-layered structure is longer than a length in the height direction of the MR multi-layered structure, and a bottom surface of the upper magnetic shield layer is formed flat.

In the thin-film magnetic head with a wide-type magnetic domain control layer, the bottom surface of the upper magnetic shield layer is formed to have flatness. As a result, it is possible to have a good stabilization in MR output even when the read gap is narrowed to satisfy higher recording density demands.

It is preferred that the thin-film magnetic head further includes an inductive write head element formed on the upper magnetic shield layer of the MR read head element.

It is also preferred that the MR multi-layered structure includes a TMR multi-layered film or a CPP-GMR multi-layered film.

Further objects and advantages of the present invention will be apparent from the following description of the preferred embodiments of the invention as illustrated in the accompanying drawings.

### BRIEF DESCRIPTION OF THE DRAWINGS

FIGS. 1a and 1b, already described, show plane views illustrating a lamination plane of an MR read head element with a wide-type magnetic domain control bias layer;

FIGS. 2a and 2b, already described, show plane views illustrating a lamination plane of an MR read head element with a narrow-type magnetic domain control bias layer;

FIG. 3 shows a flow chart schematically illustrating a manufacturing process of a thin-film magnetic head as an embodiment according to the present invention;

FIG. 4 is a cross-sectional view schematically illustrating a configuration of the thin-film magnetic head fabricated by the embodiment shown in FIG. 3;

FIG. 5 is a flowchart illustrating in detail a manufacturing process of a read head element in the manufacturing process shown in FIG. 3;

FIGS. 6a to 6j show cross-sectional views illustrating the manufacturing process shown in FIG. 5;

FIG. 7 is a flowchart illustrating in detail a manufacturing process of a read head element in a manufacturing process of a thin-film magnetic head as another embodiment according to the present invention; and

FIGS. 8a to 8j show cross-sectional views illustrating the manufacturing process shown in FIG. 7.

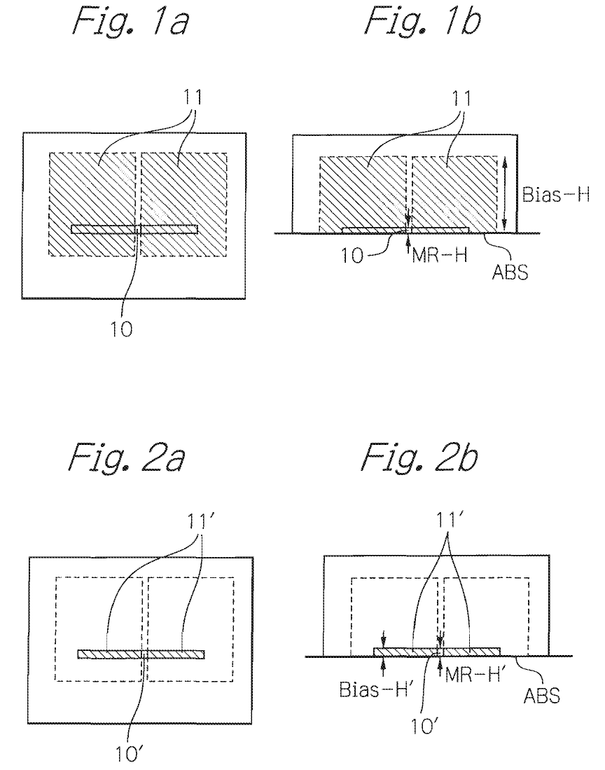

### DESCRIPTION OF THE PREFERRED EMBODIMENTS

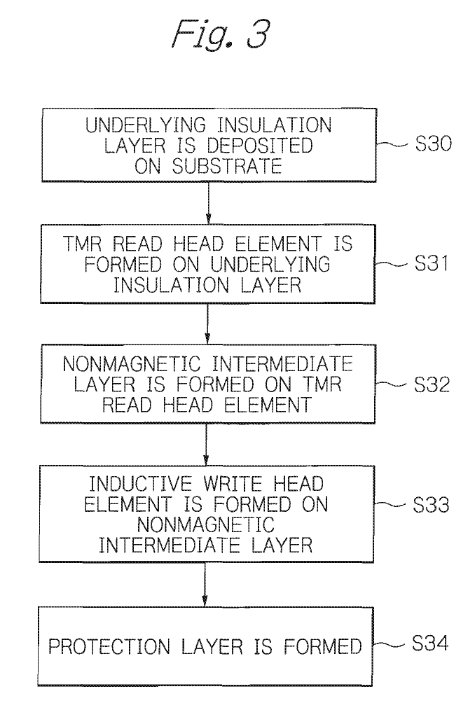

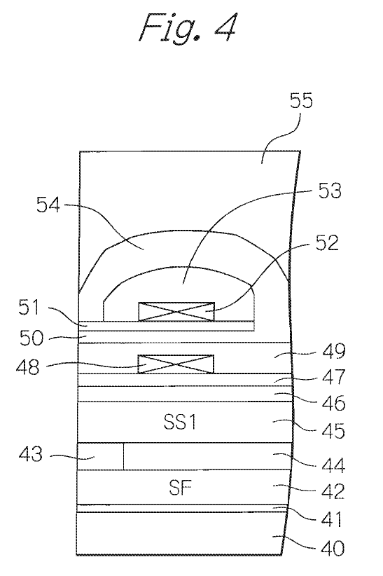

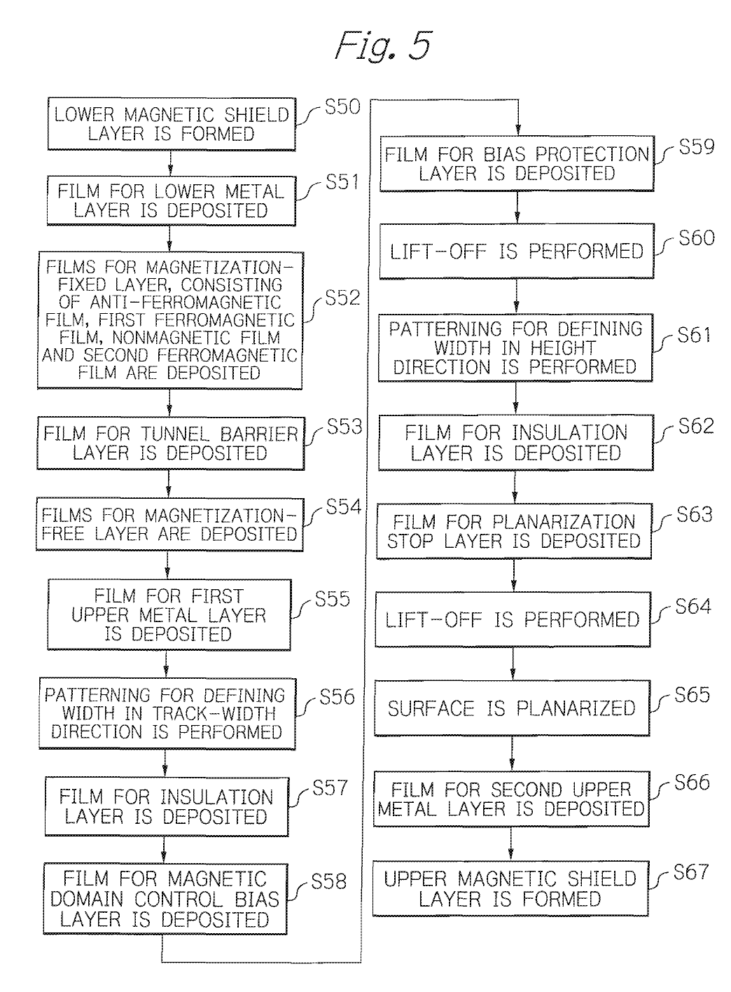

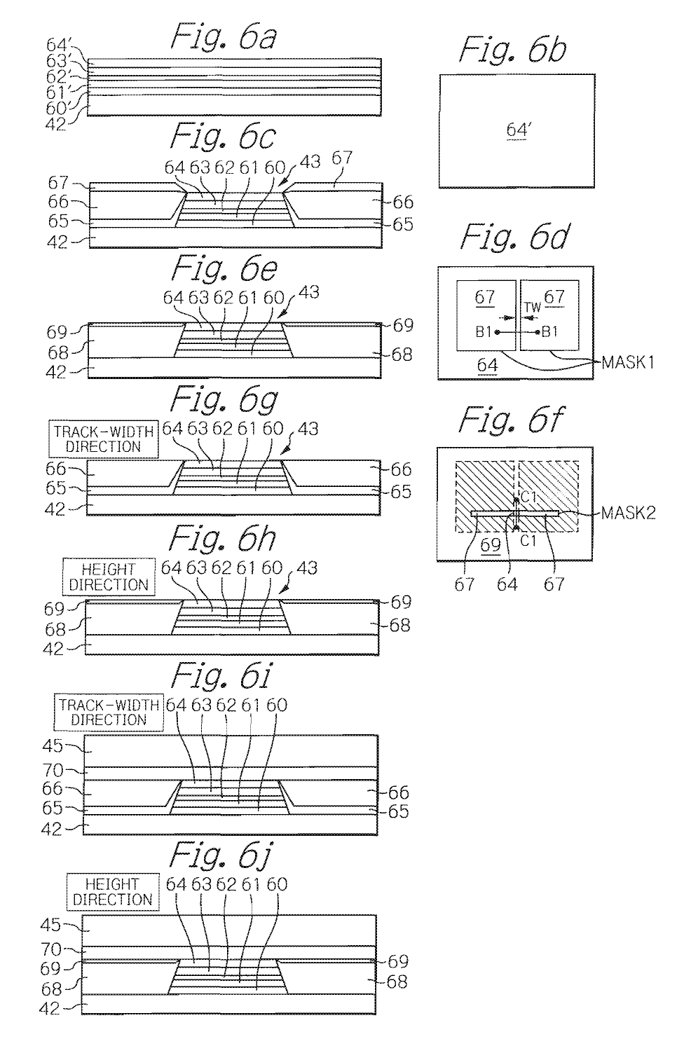

FIG. 3 illustrates a process for manufacturing a thin-film magnetic head according to an embodiment of the present invention, FIG. 4 schematically illustrates a configuration of the thin-film magnetic head manufactured according to the embodiment shown in FIG. 3, FIG. 5 illustrates in further detail the step of manufacturing a read head element in the manufacturing process shown in FIG. 3, and FIGS. 6a to 6j illustrate the manufacturing process shown in FIG. 5. It should be noted that FIG. 4 shows a cross section of the thin-film magnetic head that is perpendicular to an air bearing surface (ABS) and track-width direction of the thin-film magnetic head.

While a TMR thin-film magnetic head is manufactured in this embodiment, the basically same process can manufacture a GMR thin-film magnetic head having a CPP structure except that a nonmagnetic conducting layer is formed instead of a tunnel barrier layer.

As shown in FIGS. 3 and 4, a substrate or wafer 40 made of a conductive material such as AlTic (Al₂O₃—TiC) is prepared first, and an underlying insulation layer 41 of an insulation material such as alumina (Al₂O₃) or silicon oxide (SiO₂) is deposited on the substrate 40 to have a thickness of about 0.05 to 10 μm by a sputtering method for example (Step S30).

Then, a TMR read head element including a lower magnetic shield layer (SF) 42 that also acts as a lower electrode layer, a TMR multi-layered structure 43, an insulation layer 44, an insulation layer 65 (see FIG. 6c), a magnetic domain control bias layer 66 (see FIG. 6c), a bias protection layer 67 (see FIG. 6c), and an upper magnetic shield layer (SS1) 45 that also acts as an upper electrode is formed on the underlying insulation layer 41 (Step S31). A process for manufacturing the TMR read head element will be described later in detail.

Then, a nonmagnetic intermediate layer 46 is formed on the TMR read head element (Step S32). The nonmagnetic intermediate layer 46 is a layer made of an insulation material such as Al₂O₃, SiO₂, aluminum nitride (AlN) or diamond-like carbon (DLC), or a metal material such as titanium (Ti), tantalum (Ta) or platinum (Pt) with a thickness of about 0.1 to 0.5 Hun and formed by for example a sputtering method or chemical vapor deposition (CVD) method. The nonmagnetic intermediate layer 46 separates the TMR read head element from an inductive write head element that will be formed on it.

Then, the inductive write head element including an insulation layer 47, a backing coil layer 48, a backing coil insulation layer 49, a main pole layer 50, an insulation gap layer 51, a write coil layer 52, a write coil insulation layer 53 and an auxiliary pole layer 54 is formed on the nonmagnetic intermediate layer 46 (Step S33). The inductive write head element in this embodiment has a perpendicular magnetic recording structure. However, it will be apparent that an inductive write head element having a horizontal or in-plane magnetic recording structure can be used. It will be also apparent that the perpendicular magnetic recording structure of the inductive write head element is not limited to the structure shown in FIG. 4 but instead any of various other structures can be used.

The insulation layer 47 is formed by depositing an insulation material such as Al₂O₃ or SiO₂ for example on the nonmagnetic intermediate layer 46 by using a sputtering method, for example. The upper surface of the insulating layer 47 is planarized by CMP, for example, as required. Formed on the insulation layer 47 is the baking coil layer 48 of a conductive material such as copper (Cu) by using such as a frame plating method for example to have a thickness of about 1 to 5 μm. The purpose of the backing coil layer 48 is to guide a write magnetic flux so as to prevent adjacent track erasure (ATE). The backing coil insulation layer 49 is formed to have a thickness of about 0.5 to 7 μm by photolithography a thermoset novolac resist so as to cover the backing coil layer 48.

The main magnetic pole layer 50 is formed on the backing coil insulation layer 49. The main magnetic pole layer 50 acts as a magnetic path for converging and guiding a magnetic flux induced by the write coil layer 52 to a perpendicular recording layer of a magnetic disk on which data is to be written. The main magnetic pole layer 50 is made of a metal magnetic material such as nickel iron (NiFe), cobalt iron (CoFe), iron nickel cobalt (FeNiCo), iron aluminum silicide (FeAlSi), iron nitride (FeN), iron zirconium nitride (FeZrN), iron tantalum nitride (FeTaN), cobalt zirconium niobium (CoZrNb) or cobalt zirconium tantalum (CoZrTa), or a multi-layered film including these to have a thickness of about 0.5 to 3 μm by such as a frame plating method.

The insulation gap layer 51 is formed on the main magnetic pole layer 50 by depositing an insulating film of a material such as Al₂O₃ or SiO₂ by using such as a sputtering method. Formed on the insulation gap layer 51 is the write coil insulation layer 53 of a thermoset novolac resist for example with a thickness of about 0.5 to 7 μm. The write coil layer 52 of a conductive material such as Cu with a thickness of about 1 to 5 μm is formed inside the write coil insulation layer 53 by such as a frame plating method.

The auxiliary magnetic pole layer 54 of a metal magnetic material such as FeAlSi, NiFe, CoFe, NiFeCo, FeN, FeZrN, FeTaN, CoZrNb or CoZrTa, or a multi-layered film of any of these materials with a thickness of about 0.5 to 3 μm is formed by such as a frame plating method so as to cover the write coil insulation layer 53. The auxiliary magnetic pole layer 54 forms a return yoke.

Then, a protection layer 55 is formed on the inductive write head element (Step S34). The protection layer 55 may be formed by depositing a material such as Al₂O₃ or SiO₂ using a sputtering method.

This completes the wafer process for the thin-film magnetic head. In the subsequent processes for manufacturing the thin-film magnetic head such as a machining process, the wafer on which many of thin-film magnetic heads are formed is cut into a plurality of bars so that each bar has a plurality of thin-film magnetic heads aligned with each other. Then, each bar is lapped to adjust the MR height and thereafter each bar is cut into a plurality of individual thin-film magnetic heads. Such machining process is well known and therefore detail description of which will be omitted.

A process for manufacturing a TMR read head element will be described in detail with reference to FIG. 5 and FIGS. 6a to 6j.

First, a lower magnetic lower shield layer 42 that also acts as a lower electrode layer is formed on the underlying insulation layer 41 shown in FIG. 4 (Step S50). The lower magnetic shield layer 42 may be made of a metal magnetic material such as NiFe, CoFe, FeNiCo, FeAlSi, FeN, FeZrN, FeTaN, CoZrNb or CoZrTa by a frame plating method to have a thickness of approximately 0.1 to 3 μm. In a desired embodiment, a NiFe layer with a thickness of about 2 μm is deposited as the lower magnetic shield layer 42.

Then, on the lower magnetic shield layer 42, films 60′ for lower metal layer are deposited by a sputtering method for example (Step S51). The films 60′ for lower metal layer consist of a film made of a material such as Ta, chromium (Cr), hafnium (Hf), niobium (Nb), zirconium (Zr), Ti, molybdenum (Mo) or tungsten (W) with a thickness of about 0.5 to 5 nm, and a film made of a material such as ruthenium (Ru), NiCr, NiFe, NiFeCr, cobalt (Co) or CoFe with a thickness of about 1 to 6 nm in a desired embodiment, a Ta film with a thickness of about 1 nm is deposited and a Ru film with a thickness of about 2 nm is deposited thereon, as the films 60′ for lower metal layer.

Then, films 61′ for magnetization-fixed layer are deposited on the films 60′ for lower metal layer (Step S52). The films 61′ for magnetization-fixed layer in this embodiment are of synthetic type, formed by depositing in this order, using a sputtering method for example, an anti-ferromagnetic film (film for pinning layer) of a material such as IrMn, PtMn, NiMn or RuRhMn with a thickness of about 5 to 30 nm, a first ferromagnetic film of a material such as CoFe with a thickness of about 1 to 5 nm, a nonmagnetic film of an alloy of one or more of materials such as Ru; rhodium (Rh), iridium (Ir), Cr, rhenium (Re) and Cu with a thickness of about 0.8 nm, and a second ferromagnetic film of material such as CoFe, CoFeSi, CoMnGe, CoMnSi or CoMnAi with a thickness of about 1 to 3 nm. In a desired embodiment, an IrMn film with a thickness of about 7 nm is deposited, a CoFe film with a thickness of about 2 nm is deposited thereon, a Ru film with a thickness of about 0.8 nm is deposited thereon and a CoFe film with a thickness of about 3 nm is deposited thereon, as the films 61′ for magnetization-fixed layer.

Then, a film 62′ for tunnel barrier layer, made of oxidation of an aluminum (Al), Ti, Ta, Zr, Hf, magnesium (Mg), silicon (Si) or zinc (Zn) with a thickness of about 0.5 to 1 nm is deposited on the films 61′ for magnetization-fixed layer by such as a sputtering method (Step S53). In a desired embodiment, a Al₂O₃ film with a thickness of about 0.6 nm is deposited as a film 62′ for tunnel barrier layer.

Thereafter, films 63′ for magnetization-free layer (free layer) are deposited on the film 62′ for tunnel barrier layer by sputtering for example a high-polarizability film of a material such as CoFe, CoFeSi, CoMnGe, CoMnSi or CoMnAl with a thickness of about 1 nm and a soft magnetic film of a material such as NiFe with a thickness of about 1 to 9 nm in this order (Step S54). In a desired embodiment, a CoFe film with a thickness of about 1 nm is deposited, and a NiFe film with a thickness of about 3 nm is deposited thereon, as the films 63′ for magnetization-free layer.

Then, a film 64′ for first upper metal layer consisting of one or more layers of a nonmagnetic conductive material such as Ta, Ru, Hf, Nb, Zr, Ti, Cr or W with a thickness of about 1 to 10 mm is deposited by such as a sputtering method (Step S55). In a desired embodiment, a Ta film with a thickness of about 5 nm is deposited as the films 64′ for first upper metal layer. FIGS. 6a and 6b show this state. It should be noted that FIG. 6a shows a section parallel to the ABS of this thin-film magnetic head and FIG. 6b shows a plane view of the lamination plane.

Then, a patterning process is performed to define or adjust the width TW in the track width direction of the TMR multi-layered film thus formed (Step S56). Namely, at this step S56, first, a mask (not shown) having a resist pattern used for lift off is formed on the multi-layered film, and then ion milling such as ion beam etching with Ar ions through the mask to the TMR multi-layered film is performed. This mask has openings corresponding to MASK1 shown in FIG. 6d. As a result of this milling, the TMR multi-layered structure 43 with the lower metal layer 60, the magnetization-fixed layer 61, the tunnel barrier layer 62, the magnetization-free layer 63 and the first upper metal layer 64 shown in FIG. 6c can be obtained.

Then, a film for insulation layer, made of an insulation material such as Al₂O₃ or SiO₂, is deposited thereon by ion beam deposition (IBD) for example to have a thickness of about 3 to 20 nm (Step S57). Then, an under film made of for example Cr with a thickness of about 3 nm and a film for ferromagnetic layer made of a material mainly composed of Co, such as CoPt alloy, with a thickness of about 10 to 40 nm are deposited thereon by sputtering or IBD as films for a magnetic domain control bias layer (Step S58). Thereafter, a sufficiently thick film for bias protection layer made of for example Cr with a thickness of about 50 nm is deposited thereon by sputtering or IBD (Step S59). In a desired embodiment, a Al₂O₃ film with a thickness of about 10 nm is deposited as the film for insulation layer, a Cr film with a thickness of about 3 nm is deposited as the film for under film of the magnetic domain control bias layer, a CoPt film with a thickness of about 25 nm is deposited as the film for ferromagnetic film of the magnetic domain control bias layer, and a Cr film with a thickness of about 50 nm is deposited as the film for bias protection layer.

Then, lift off process is performed by removing the mask (Step S60). FIGS. 6c and 6d indicate this state. It should be noted that FIG. 6c shows a section (B1-B1 section) parallel to the ABS of this thin-film magnetic head and FIG. 6d shows a plane view of the lamination plane. As will be understood from FIG. 6c, on the side surfaces of the TMR multi-layered structure 43 and on the lower magnetic shield layer 42, an insulation layer 65, a magnetic domain control bias layer 66 and a bias protection layer 67 are laminated.

Then, a patterning process is performed to define or adjust a width in the height direction that is perpendicular to the track-width direction of the TMR multi-layered structure thus formed 43 (Step S61). Namely, at this step S61, first, a mask (not shown) having a resist pattern used for lift off is formed on the first upper metal layer 64 of the TMR multi-layered structure 43 and on the bias protection layer 67, and then ion milling such as ion beam etching with Ar ions through the mask to the TMR multi-layered film is performed. This mask covers only parts corresponding to MASK2 shown in FIG. 6f. As a result of this milling, a part uncovered by the mask, of the TMR multi-layered structure 43 is mostly removed, but because the bias protection layer 67 is thick, the entire magnetic domain control bias layer 66 is remained without being removed.

Then, a film for insulation layer, made of an insulation material such as Al₂O₃ or SiO₂, is deposited thereon by sputtering or IBD for example to have a thickness of about 60 nm (Step S62), and a film made of for example Ta with a thickness of about 5 nm is deposited thereon by sputtering or IBD as a planarization-stop film (Step S63). In a desired embodiment, a Al₂O₃ film with a thickness of about 60 nm is deposited, and a Ta film with a thickness of about 5 nm is deposited as the film for planarization-stop film.

Thereafter, lift off process is performed by removing the mask (Step S64). FIGS. 6e and 6f indicate this state. It should be noted that FIG. 6e shows a section (C1-C1 section) perpendicular to the ABS of this thin-film magnetic head and FIG. 6f shows a plane view of the lamination plane. As will be understood from FIG. 6e, on the front and backsides in the height direction of the TMR multi-layered structure 43 and on the lower magnetic shield layer 42, an insulation layer 68 and a planarization-stop film 69 are laminated in this order.

Then, the surface thereof is planarized by CMP (Step S65). The planarization operation is stopped in response to the planarization stop film 69 that covers almost entire surface of the wafer. FIGS. 6g and 6h indicate the planarized state. It should be noted that FIG. 6g shows a section parallel to the ABS of this thin-film magnetic head and FIG. 6h shows a section perpendicular to the ABS of the thin-film magnetic head. As will be understood from FIG. 6g, the almost entire bias protection layer 67 is removed and upper surfaces of the magnetic domain control bias layer 66 and the first upper metal layer 64 are planarized. Instead of performing CMP, the bias protection layer 67 may be formed by for example Al₂O₃ and wet etching using such as alkaline liquid solution may be performed for planarization. In the latter case, the planarization stop film 69 is utilized as a stop film of the wet etching.

Thereafter, a second upper metal layer 70 made of for example Ru with a thickness of about 6 nm is formed by sputtering to sequentially cover the first upper metal layer 64 of the TMR multi-layered structure 43 and the magnetic domain control bias layer 66 (Step S66). In a desired embodiment, a Ru film with a thickness of about 6 nm is deposited as the second upper metal layer 70. It may be possible to remove the planarization stop film 69 before depositing the second upper metal layer 70.

Then, on the second upper metal layer 70, an upper magnetic shield layer 45, which also acts as an upper electrode layer, of a metal magnetic material such as NiFe, CoFe, NiFeCo, FeAlSi, FeN, FeZrN, FeTaN, CoZrNb or CoZrTa with a thickness of approximately 0.1 to 3 μm is formed by such as a frame plating method (Step S67)₃. In a desired embodiment, a NiFe film with a thickness of about 2 nm is deposited as the upper magnetic shield layer 45. FIGS. 6i and 6j indicate this state. It should be noted that FIG. 6i shows a section parallel to the ABS of this thin-film magnetic head and FIG. 6j shows a section perpendicular to the ABS of the thin-film magnetic head.

In a modification of this embodiment, the planarization process such as CMP at Step S65 may be performed without executing the lift-off process at Step S64. Thus, at Step S65, the mask and layers laminated on the mask are removed all together by the planarization. In another modification of this embodiment, the planarization process such as CMP or wet etching is performed without forming a planarization Stop film.

The layer structure, material and thickness of each of the magnetization-fixed layer, barrier layer and the magnetization-free layer that constitute the magneto-sensitive portion of the TMR multi-layered structure 43 are not limited to that described above, but various materials and thicknesses may be optionally adopted. For example, the magnetization-fixed layer is not limited to the three-layered films plus the anti-ferromagnetic film, but may be formed from a single-layer film made of a ferromagnetic film plus the anti-ferromagnetic film, or multi-layered films other than three films plus the anti-ferromagnetic film. The magnetization-free layer is not limited to the two-layered films, but may be formed from a single-layer film other than the high-polarizability film or multi-layered films of more than two films with a magnetostriction control film. Furthermore, the magnetization-fixed layer, barrier layer and magnetization-free layer of the magneto-sensitive portion may be formed in the inverse order, that is, in the order of the magnetization-free layer, the barrier layer and the magnetization-fixed layer from the bottom. In that case, the anti-ferromagnetic film in the magnetization fixed layer will be positioned at the top.

As has been described above, according to this embodiment, the planarization process of surfaces is performed after the patterning process at Step S61 for defining the width in the height direction but before the forming process at Step S66 for forming the second upper metal layer 70. Thus; almost the entire bias protection layer 67 can be removed, and the upper surface of the second upper metal layer 70, on which the upper magnetic shield layer 45 is laminated, can be made flat even if the wide-type magnetic domain control bias layer 66 is provided. Therefore, the upper magnetic shield layer 45 can be formed with good flatness, and as a result it is possible to provide a thin-film magnetic head with an MR read head element having a good stabilization in MR output even when the read gap is narrowed to satisfy higher recording density demands.

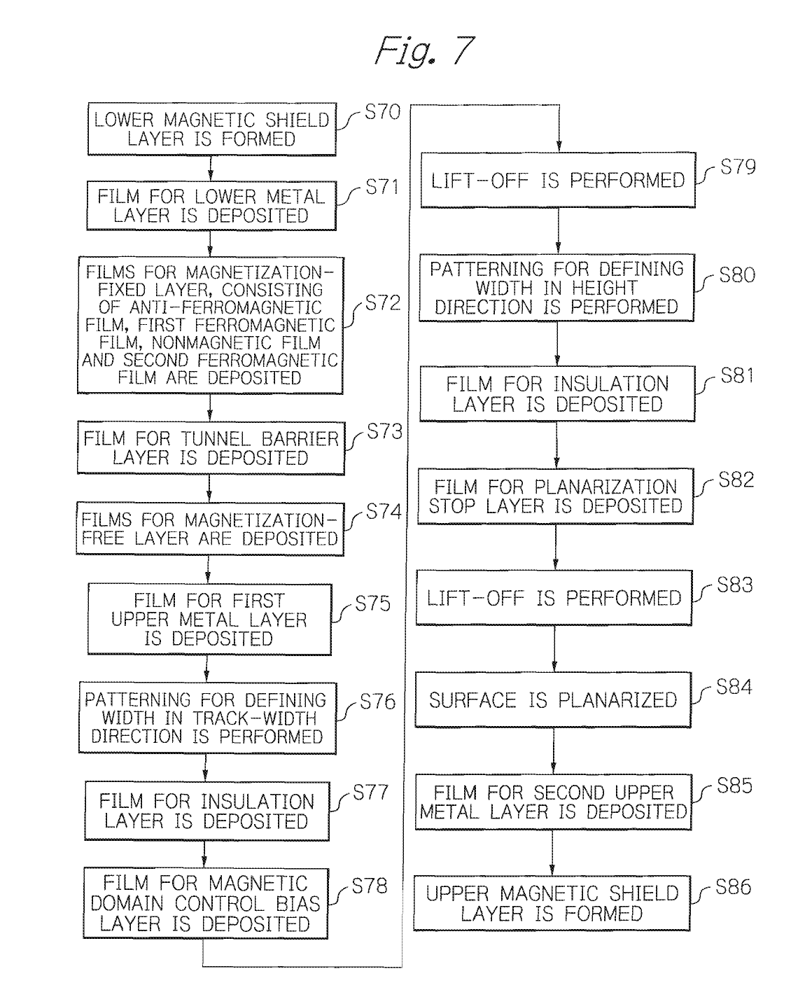

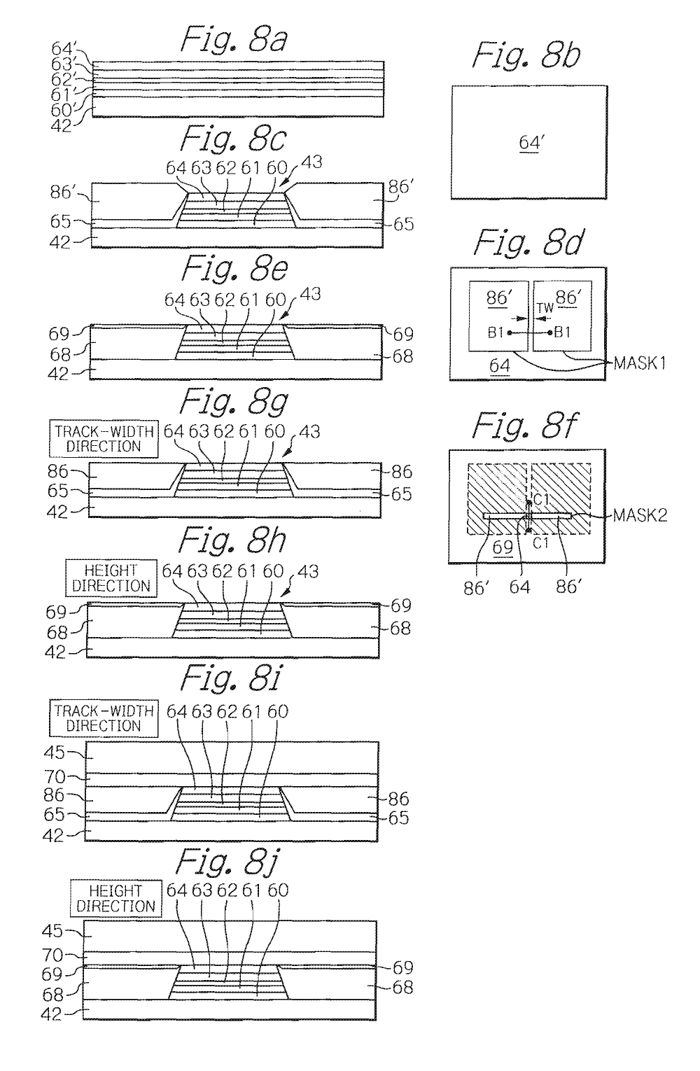

FIG. 7 illustrates in detail a manufacturing process of a read head element in a manufacturing process of a thin-film magnetic head as another embodiment according to the present invention, and FIGS. 8a to 8j illustrate the manufacturing process shown in FIG. 7.

While a TMR thin-film magnetic head is manufactured in this embodiment, a GMR thin-film magnetic head having a CPP structure can be manufactured by the basically same process except that a nonmagnetic conducting layer is formed instead of a tunnel barrier layer.

In this embodiment, a manufacturing process of the thin-film magnetic head except for that of a TMR read head element is the same as that shown in FIGS. 3 and 4 and therefore description thereof is omitted. Also, the same reference numerals for the similar components as those in FIG. 3 are used in this embodiment.

A process for manufacturing a TMR read head element will be described in detail with reference to FIG. 7 and FIGS. 8a to 8j.

First, a lower magnetic lower shield layer 42 (see FIG. 4) that also acts as a lower electrode layer is formed on the underlying insulation layer 41 (Step S70). The lower magnetic shield layer 42 may be made of a metal magnetic material such as NiFe, CoFe, FeNiCo, FeAlSi, FeN, FeZrN, FeTaN, CoZrNb or CoZrTa by a frame plating method to have a thickness of approximately 0.1 to 3 μm. In a desired embodiment, a NiFe layer with a thickness of about 2 μm is deposited as the lower magnetic shield layer 42.

Then, on the lower magnetic shield layer 42, films 60′ for lower metal layer are deposited by a sputtering method for example (Step S71). The films 60′ for lower metal layer consist of a film made of a material such as Ta, Cr, Hf, Nb, Zr, Ti, Mo or W with a thickness of about 0.5 to 5 nm, and a film made of a material such as Ru, NiCr, NiFe, NiFeCr, Co or CoFe with a thickness of about 1 to 6 nm. In a desired embodiment, a Ta film with a thickness of about 1 nm is deposited and a Ru film with a thickness of about 2 nm is deposited thereon, as the films 60′ for lower metal layer.

Then, films 61′ for magnetization-fixed layer are deposited on the films 60′ for lower metal layer (Step S72). The films 61′ for magnetization-fixed layer in this embodiment are of synthetic type, formed by depositing in this order, using a sputtering method for example, an anti-ferromagnetic film (film for pinning layer) of a material such as IrMn, PtMn₅ NiMn or RuRhMn with a thickness of about 5 to 30 nm, a first ferromagnetic film of a material such as CoFe with a thickness of about 1 to 5 nm, a nonmagnetic film of an alloy of one or more of materials such as Ru, Rn, Ir, Cr, Re and Cu with a thickness of about 0.8 nm, and a second ferromagnetic film of material such as CoFe, CoFeSi, CoMnGe, CoMnSi or CoMnAl with a thickness of about 1 to 3 nm. In a desired embodiment, an IrMn film with a thickness of about 7 nm is deposited, a CoFe film with a thickness of about 2 nm is deposited thereon, a Ru film with a thickness of about 0.8 nm is deposited thereon and a CoFe film with a thickness of about 3 nm is deposited thereon, as the films 61′ for magnetization-fixed layer.

Then, a film 62′ for tunnel barrier layer, made of oxidation of Al, Ti, Ta, Zr, Hf, Mg, Si or Zn with a thickness of about 0.5 to 1 nm is deposited on the films 61′ for magnetization-fixed layer by such as a sputtering method (Step S73). In a desired embodiment, a Al₂O₃ film with a thickness of about 0.6 nm is deposited as a film 62′ for tunnel barrier layer.

Thereafter, films 63′ for magnetization-free layer (free layer) are deposited on the film 62′ for tunnel barrier layer by sputtering for example a high-polarizability film of a material such as CoFe, CoFeSi, CoMnGe, CoMnSi or CoMnAl with a thickness of about 1 nm and a soft magnetic film of a material such as NiFe with a thickness of about 1 to 9 nm in this order (Step S74). In a desired embodiment, a CoFe film with a thickness of about 1 nm is deposited, and a NiFe film with a thickness of about 3 nm is deposited thereon, as the films 63′ for magnetization-free layer.

Then, a film 64′ for first upper metal layer consisting of one or more layers of a nonmagnetic conductive material such as Ta, R, Hf, Nb, Zr, Ti, Cr or W with a thickness of about 1 to 10 nm is deposited by such as a sputtering method (Step S75). In a desired embodiment, a Ta film with a thickness of about 5 nm is deposited as the films 64′ for first upper metal layer. FIGS. 8a and 8b show this state. It should be noted that FIG. 8a shows a section parallel to the ABS of this thin-film magnetic head and FIG. 8b shows a plane view of the lamination plane.

Then, a patterning process is performed to define or adjust the width TW in the track width direction of the TMR multi-layered film thus formed (Step S76). Namely, at this step S76, first, a mask (not shown) having a resist pattern used for lift off is formed on the multi-layered film, and then ion milling such as ion beam etching with Ar ions through the mask to the TMR multi-layered film is performed. This mask has openings corresponding to MASK1 shown in FIG. 8d. As a result of this milling, the TMR multi-layered structure 43 with the lower metal layer 60, the magnetization-fixed layer 61, the tunnel barrier layer 62, the magnetization-free layer 63 and the first upper metal layer 64 shown in FIG. 8c can be obtained.

Then, a film for insulation layer, made of an insulation material such as Al₂O₃ or SiO₂₁ is deposited thereon by IBD for example to have a thickness of about 3 to 20 nm (Step S77). Then, an under film made of for example Cr with a thickness of about 3 nm and a film for ferromagnetic layer made of a material mainly composed of Co, such as CoPt alloy, with a thickness of about 60 to 90 nm are deposited thereon by sputtering or IBD as films for a magnetic domain control bias layer (Step S78). In this embodiment, no film for bias protection layer is deposited but instead thereof the sufficiently thick film for ferromagnetic layer is deposited. In a desired embodiment, a Al₂O₃, film with a thickness of about 10 nm is deposited as the film for insulation layer, a Cr film with a thickness of about 3 nm is deposited as the film for under film of the magnetic domain control bias layer, and a CoPt film with a thickness of about 75 nm is deposited as the film for ferromagnetic film of the magnetic domain control bias layer.

Then, lift off process is performed by removing the mask (Step S79). FIGS. 8c and 8d indicate this state. It should be noted that FIG. 8c shows a section (B1-B1 section) parallel to the ABS of this thin-film magnetic head and FIG. 8d shows a plane view of the lamination plane. As will be understood from FIG. 8c, on the side surfaces of the TMR multi-layered structure 43 and on the lower magnetic shield layer 42, an insulation layer 65 and a magnetic domain control bias layer 86′ are laminated.

Then, a patterning process is performed to define or adjust a width in the height direction that is perpendicular to the track-width direction of the TMR multi-layered structure thus formed 43 (Step S80). Namely, at this step S80, first, a mask (not shown) having a resist pattern used for lift off is formed on the first upper metal layer 64 of the TMR multi-layered structure 43 and on the magnetic domain control bias layer 86′, and then ion milling such as ion beam etching with Ar ions through the mask to the TMR multi-layered film is performed. This mask covers only parts corresponding to MASK2 shown in FIG. 8f. As a result of this milling, a part uncovered by the mask, of the TAR multi-layered structure 43 is mostly removed, but because it is thick, the entire magnetic domain control bias layer 86′ is remained without being removed.

Then, a film for insulation layer, made of an insulation material such as Al₂O₃ or SiO₂, is deposited thereon by sputtering or IBD for example to have a thickness of about 60 nm (Step S81), and a film made of for example Ta with a thickness of about 5 nm is deposited thereon by sputtering or IBD as a planarization-stop fin (Step S82). In a desired embodiment, a Al₂O₃ film with a thickness of about 60 nm is deposited, and a Ta film with a thickness of about 5 nm is deposited as the film for planarization-stop film.

Thereafter lift off process is performed by removing the mask (Step S83). FIGS. 8e and 8f indicate this state. It should be noted that FIG. 8e shows a section (C1-C1 section) perpendicular to the ABS of this thin-film magnetic head and FIG. 8f shows a plane view of the lamination plane. As will be understood from FIG. 8e, on the front and backsides in the height direction of the TMR multi-layered structure 43 and on the lower magnetic shield layer 42, an insulation layer 68 and a planarization-stop film 69 are laminated in this order.

Then, the surface thereof is planarized by CMP (Step S84). The planarization operation is stopped in response to the planarization stop film 69 that covers almost entire surface of the wafer. FIGS. 8g and 8h indicate the planarized state. It should be noted that FIG. 8g shows a section parallel to the ABS of this thin-film magnetic head and FIG. 8h shows a section perpendicular to the ABS of the thin-film magnetic head. As will be understood from FIG. 8g, a part of the magnetic domain control bias layer 86′ is removed to form a magnetic domain control bias layer 86 with a planarized upper surface and a first upper metal layer 64 with a planarized upper surface.

Thereafter, a second upper metal layer 70 made of for example Ru with a thickness of about 6 nm is formed by sputtering to sequentially cover the first upper metal layer 64 of the TMR multi-layered structure 43 and the magnetic domain control bias layer 86 (Step S85). In a desired embodiment, a Ru film with a thickness of about 6 nm is deposited as the second upper metal layer 70. It may be possible to remove the planarization stop film 69 before depositing the second upper metal layer 70.

Then, on the second upper metal layer 70, an upper magnetic shield layer 45, which also acts as an upper electrode layer, of a metal magnetic material such as NiFe, CoFe, NiFeCo, FeAlSi, FeN, FeZrN, FeTaN, CoZrNb or CoZrTa with a thickness of approximately 0.1 to 3 μm is formed by such as a frame plating method (Step S86). In a desired embodiment, a NiFe film with a thickness of about 2 nm is deposited as the upper magnetic shield layer 45. FIGS. 8i and 8j indicate this state. It should be noted that FIG. 8i shows a section parallel to the ABS of this thin-film magnetic head and FIG. 8j shows a section perpendicular to the ABS of the thin-film magnetic heads.

In a modification of this embodiment, the planarization process such as CMP at Step S84 may be performed without executing the lift-off process at Step S83. Thus, at Step S84, the mask and layers laminated on the mask are removed all together by the planarization. In another modification of this embodiment, the planarization process such as CMP or wet etching is performed without forming a planarization Stop film.

The layer structure, material and thickness of each of the magnetization-fixed layer, barrier layer and the magnetization-free layer that constitute the magneto-sensitive portion of the TMR multi-layered structure 43 are not limited to that described above, but various materials and thicknesses may be optionally adopted. For example, the magnetization-fixed layer is not limited to the three-layered films plus the anti-ferromagnetic film, but may be formed from a single-layer film made of a ferromagnetic film plus the anti-ferromagnetic film, or multi-layered films other than three films plus the anti-ferromagnetic film. The magnetization-free layer is not limited to the two-layered films, but may be formed from a single-layer film other than the high-polarizability film or multi-layered films of more than two films with a magnetostriction control film, Furthermore, the magnetization-fixed layer, barrier layer and magnetization-free layer of the magneto-sensitive portion may be formed in the inverse order, that is, in the order of the magnetization-free layer, the barrier layer and the magnetization-fixed layer from the bottom. In that case, the anti-ferromagnetic film in the magnetization fixed layer will be positioned at the top.

As has been described above, according to this embodiment, the planarization process of surfaces is performed after the patterning process at Step S80 for defining the width in the height direction but before the forming process at Step S85 for forming the second upper metal layer 70. Thus, a part of the upper surface of the magnetic domain control bias layer 86 is removed, and the upper surface of the second upper metal layer 70, on which the upper magnetic shield layer 45 is laminated, can be made flat even if the wide-type magnetic domain control bias layer 86 is provided. Therefore, the upper magnetic shield layer 45 can be formed with good flatness, and as a result it is possible to provide a thin-film magnetic head with an MR read head element having a good stabilization in MR output even when the read gap is narrowed to satisfy higher recording density demands. Furthermore, in this embodiment, since no bias protection film is deposited, a problem that a part of the bias protection layer remains after the planarization process never occurs.

Many widely different embodiments of the present invention may be constructed without departing from the spirit and scope of the present invention. It should be understood that the present invention is not limited to the specific embodiments described in the specification, except as defined in the appended claims.

1. A manufacturing method of a thin-film magnetic head with a magnetoresistive effect read head element, comprising:
a magnetoresistive effect film deposition step of depositing on a lower magnetic shield layer a magnetoresistive effect multi-layered film;
a first patterning step of patterning the deposited magnetoresistive effect multi-layered film for defining a track width using a first mask;
a first lift-off step of depositing at least an insulation film and a magnetic domain control film under a state where the first mask used said first patterning step is remained and removing the first mask to form a magnetic domain control layer,
a second patterning step of patterning the magnetoresistive effect multi-layered films for defining a width in a height direction that is perpendicular to a track-width direction to form a magnetoresistive effect multi-layered structure; and
a upper shield layer deposition step of depositing an upper magnetic shield layer,
a length in the height direction that is perpendicular to the track-width direction, of said magnetic domain control layer near said magnetoresistive effect multi-layered structure being longer than a length in the height direction of said magnetoresistive effect multi-layered structure, and
said method further comprising a planarization step of planarizing an upper surface, said planarization step being performed after said second patterning step but before said upper shield layer deposition step.

2. The manufacturing method as claimed in claim 1, wherein said first lift-off step comprises a step of sequentially depositing an insulation film, a magnetic domain control film and a magnetic domain control protection film under a state where the first mask used in said first patterning step is remained and a step of removing the first mask.

3. The manufacturing method as claimed in claim 1, wherein said first lift-off step comprises a step of sequentially depositing only an insulation film and a magnetic domain control film under a state where the first mask used in said first patterning step is remained and a step of removing the first mask.

4. The manufacturing method as claimed in claim 1, wherein said method further comprises a second lift-off step of depositing at least an insulation film under a state where a second mask used in said second patterning step is remained and removing the second mask, and wherein said second lift-off step is performed after said second patterning step but before said planarization step.

5. The manufacturing method as claimed in claim 4, wherein said second lift-off step comprises a step of sequentially depositing an insulation film and a planarization stop film under a state where the second mask used in said second patterning step is remained and a step of removing the second mask.

6. The manufacturing method as claimed in claim 1, wherein said method further comprises a planarization stop film deposition step of depositing an insulation film and a planarization stop film under a state where a second mask used in said second patterning step is remained, wherein said planarization stop film deposition step is performed after said second patterning step but before said planarization step, and wherein said planarization step is performed without executing lift-off.

7. The manufacturing method as claimed in claim 1, wherein said planarization step comprises a step of executing chemical mechanical polishing.

8. The manufacturing method as claimed in claim 1, wherein said planarization step comprises a step of executing wet etching.

9. The manufacturing method as claimed in claim 1, wherein said magnetoresistive effect fin deposition step comprises a step of depositing a tunnel magnetoresistive effect multi-layered film.

10. The manufacturing method as claimed in claim 1 wherein said magnetoresistive effect film deposition step comprises a step of depositing a current-perpendicular-to-plane type giant magnetoresistive effect multi-layered film.

11. The manufacturing method as claimed in claim 1, wherein said method further comprises a step of forming an inductive write head element on said upper magnetic shield layer of the magnetoresistive effect read head element.

12. The manufacturing method as claimed in claim 1, wherein said method further comprises a step of forming many thin-film magnetic heads on a wafer, a step of cutting the wafer into a plurality of bars so that each bar has a plurality of thin-film magnetic heads aligned with each other, a step of lapping each bar, and a step of separating the lapped bar into a plurality of individual thin-film magnetic heads.

13. A thin-film magnetic head with a magnetoresistive effect read head element, comprising:
a lower magnetic shield layer;
a magnetoresistive effect multi-layered structure formed on said lower magnetic shield layer, in which current flows in a direction perpendicular to a layer lamination plane;
a magnetic domain control layer formed on both side surfaces in a track-width direction of said magnetoresistive effect multi-layered structure; and
an upper magnetic shield layer formed on said magnetoresistive effect multi-layered structure and said magnetic domain control layer,
a length in a height direction that is perpendicular to the track-width direction, of said magnetic domain control layer near said magnetoresistive effect multi-layered structure being longer than a length in the height direction of said magnetoresistive effect multi-layered structure, and a bottom surface of said upper magnetic shield layer being formed flat.

14. The thin-fin magnetic head as claimed in claim 13, wherein said thin-film magnetic head further comprises an inductive write head element formed on said upper magnetic shield layer of the magnetoresistive effect read head element.

15. The thin-film magnetic head as claimed in claim 13, wherein said magnetoresistive effect multi-layered structure comprises a tunnel magnetoresistive effect multi-layered film.

16. The thin-film magnetic head as claimed in claim 13, wherein said magnetoresistive effect multi-layered structure comprises a current-perpendicular-to-plane type giant magnetoresistive effect multi-layered film.
